(19) United States
(12) Patent Application Publication
(10) Pub. No.: US 2008/0268881 A1
(43) Pub. Date: Oct. 30, 2008

(54) METHOD AND APPARATUS FOR SILENTLY FETCHING INFORMATION

(75) Inventors: AJIT MATHEWS, Plantation, FL (US); Isabel M. Fernandez, Lauderdale By Sea, FL (US); Jiji Mathews, Plantation, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/742,058

(22) Filed: Apr. 30, 2007

(51) Int. Cl. B60Q 1/54

(52) U.S. Cl. 455/466

(57) ABSTRACT

A method (200) and mobile device (120, 130) for silently fetching data is disclosed. In one arrangement, the method can include the steps of receiving (218) a silent fetch request from an originating device (120) over a wireless communication channel (300) in which the silent fetch request requests information and checking (220) the authorization of the originating device. If the originating device is an authorized device, the requested information can be fetched (222) and transmitted (224) to the originating device. As an example, the requested information can be fetched from a receiving device (130) or from a network server (140) with which the receiving device is associated. As another example, the wireless communication channel can be a traffic channel that supports at least push-to-talk communications.

### BACKGROUND OF THE INVENTION

1. Field of the Invention The present invention concerns data retrieval and more particularly, techniques for silently fetching data from a wireless device.

2. Description of the Related Art

Today's wireless devices are designed to carry significant amounts of information. As an example, many handsets include a phonebook that contains contact information associated with a number of individuals, while other mobile units include calendars that store data about a scheduled event. The information stored in a user's handset may be useful to another person. For the other person to gain access to the information, the other person has to call the user and ask for it. For example, a first person may have the cell phone number of an individual stored in the phonebook of his/her mobile unit, and a second person may wish to obtain the cell phone number. The second person must call the first person and ask for the number, which is interruptive, particularly if the incoming call is a push-to-talk call.

### SUMMARY OF THE INVENTION

A method and mobile device for silently fetching information is described below. The method can include the steps of receiving a silent fetch request from an originating device over a wireless communication channel—in which the silent fetch request requests information—and checking the authorization of the originating device. If the originating device is an authorized device, the requested information can be fetched and transmitted to the originating device. The requested information can be fetched from, for example, a receiving device or from a network server with which the receiving device is associated. In addition, the method can include the step of signaling the network server from the receiving device if the receiving device does not contain the requested information.

In one arrangement, the wireless communication channel can be a traffic channel that supports at least push-to-talk communications. Also, the receiving, checking, fetching and transmitting steps can be executed without the assistance of a user of the receiving device. As another example, the silent fetch request from the originating device can be a speech-to-text conversion. The silent fetch request may also include a preamble that the receiving device processes to identify the silent fetch request.

The method can further include the step of delaying the silent fetch request at the receiving device based on a predetermined condition. As an example, the predetermined condition can be a pre-existing active communication that is conducted on the receiving device. The method can also include the step of arranging an authorized access list that identifies both an authorized originating device and information that the authorized originating device may access.

Another method for silently fetching data is also described herein. The method can include the steps of—at a wireless originating device—selecting a wireless receiving device, identifying information to be accessed from the wireless receiving device and initiating at the wireless originating device a communication that includes a silent fetch request. In one embodiment, the silent fetch request can indicate to the wireless receiving device the identity of the wireless originating device and the information to be accessed without the assistance of a user of the wireless receiving device. Identifying information to be accessed can include converting a voice command captured at the originating device into a text command. Also, the initiated communication can be a push-to-talk communication.

A mobile device for silently fetching information is also disclosed. The mobile device can include an information store that can store information, a transceiver that can receive a silent fetch request for information from an originating mobile device and an authorizing unit coupled to the transceiver. The authorizing unit can check the authorization of the originating mobile device. The mobile device can also include a fetching unit coupled to the information store, the transceiver and the authorizing unit. Upon positive confirmation from the authorizing unit, the fetching unit can fetch the requested information from the information store, and the transceiver can transmit the requested information to the originating mobile device. This mobile device can execute any of the steps that are described in the methods above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a communication system and a block diagram of a communication device;

FIG. 2 illustrates an example of a method of silently fetching information; and

FIG. 3 illustrates an example of a traffic channel and a data packet.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” or “controller” can include any component or group of components, including any relevant hardware and/or software, that can carry out the functions described in relation to the arrangements herein.

The term “transceiver” can be any component or group of components that are capable of receiving and/or transmitting communications signals. A “silent fetch request” can be any command that seeks information from an information store with no or little interruption to a user. An “originating device” can be any electronic device that initiates a silent fetch request, and a “receiving device” can be any electronic device that is capable of receiving the silent fetch request from the originating device. The term “information” can mean any type of data that can be fetched and transmitted to the originating device. A “wireless communication channel” can mean any medium over which wireless signals may travel. An “information store” can include any suitable form of memory, including one or a plurality of components. The term “network server” can mean any storage unit not contained in the receiving unit that can store information on behalf of the receiving unit and that can be retrieved by the receiving unit.

A method and mobile device for silently fetching data is disclosed. In one arrangement, the method can include the steps of receiving a silent fetch request from an originating device over a wireless communication channel in which the silent fetch request requests information and checking the authorization of the originating device. If the originating device is an authorized device, the requested information can be fetched and transmitted to the originating device. As an example, the requested information can be fetched from a receiving device or from a network server with which the receiving device is associated. As another example, the wireless communication channel can be a traffic channel that supports at least push-to-talk communications. This process can allow a first user to remotely access information from a mobile unit without interrupting a person who is using the mobile unit.

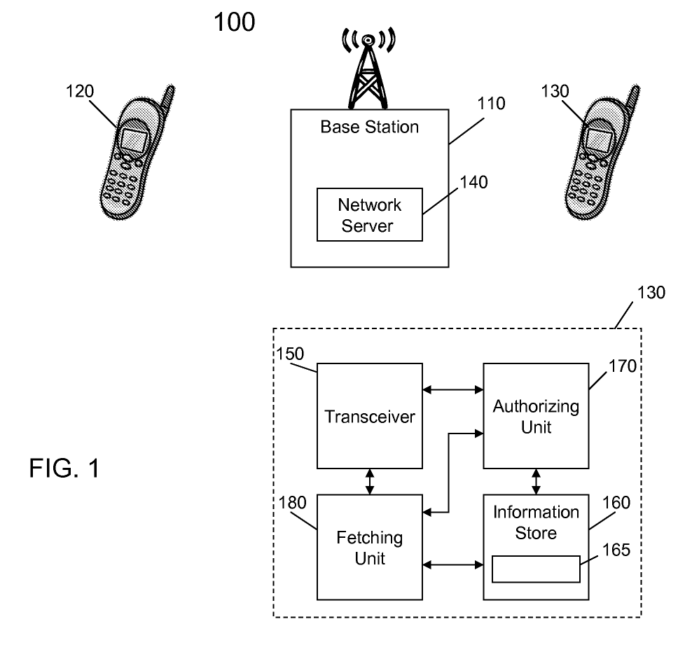

Referring to FIG. 1, a communication system 100 is shown in which a base station 110 is in wireless communications with a first mobile device 120 and a second mobile device 130. The base station 110 can be part of any suitable communications network that can facilitate communications between the first device 120 and the second device 130. As an example, the base station 110, the first device 120 and the second device 130 can all support push-to-talk (PTT) communications. A PTT communication can be defined as a communication in which a communication device initiating the communication can open up a communication channel without requiring the user of a second communication device receiving the communication to take any action in the opening of the communication channel. An example of a PTT communication is a simplex dispatch call or a push-over-cellular call. It must be understood, however, that the mobile devices 120, 130 are not limited to PTT devices, as they can support any suitable form of wireless communications. Moreover, the mobile devices 120, 130 are not necessarily limited to communicating with one another through the base station 110, as they may communicate with one another without the assistance of a communication network, i.e., the mobile devices 120, 130 can directly communicate with each other.

In one example, the first mobile device 120 may also be called an originating device 120, which refers to a device initiating a communication. In addition, the second mobile device 130 may be called a receiving device 130, which refers to a device receiving the communication initiated by the originating device 120. In another arrangement, the base station 110 may include a network server 140 that can store various types of information, as will be explained later. Those of skill in the art will also appreciate that the network server 140 can be positioned with some other suitable component of the infrastructure of a network and is not limited to being part of the base station 110.

Also shown in FIG. 1 is a block diagram of the receiving device 130. In one embodiment, the receiving device 130 may include a transceiver 150 that transmits and receives wireless signals, an information store 160 that stores information—such as an authorized access list 165—and an authorizing unit 170 that can be coupled to the transceiver 150. The receiving device 130 may also include a fetching unit 180 that can be coupled to the information store 160, the transceiver 150 and the authorizing unit 170. More information will be presented on these components down below.

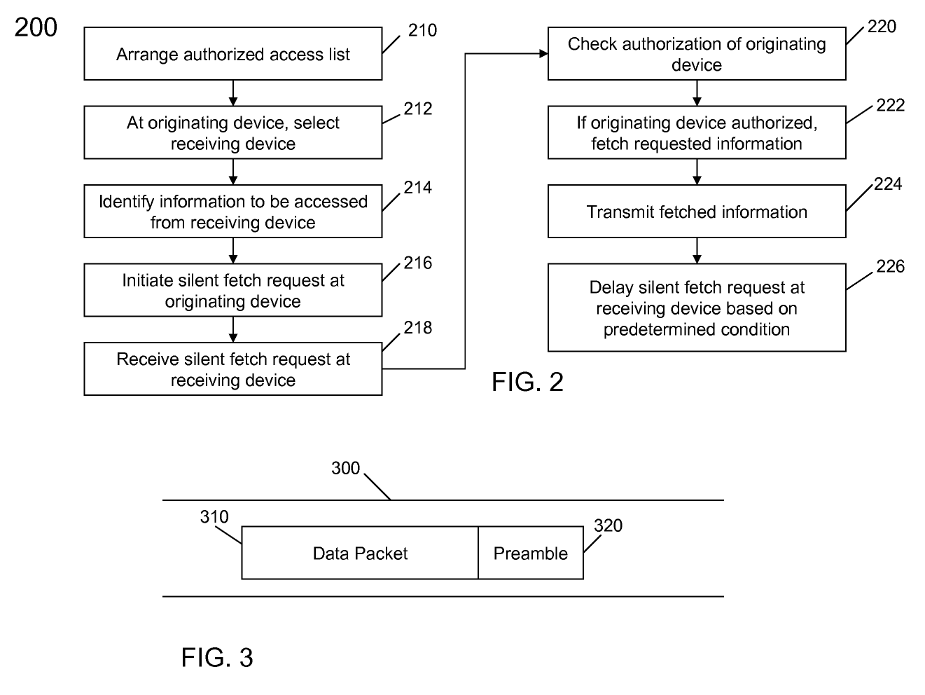

Referring to FIG. 2, a method 200 for silently fetching information is shown. When describing the method 200, reference may be made to FIG. 1, although it is understood that the method 200 may be practiced in any other suitable system or device. Reference will also be made to FIG. 3, which shows an example of a communication channel and a data packet. The steps of the method 200 are not limited to the particular order in which they are presented in FIG. 2. Moreover, the method can also have a greater number of steps or a fewer number of steps than those shown in FIG. 2.

At step 210, an authorized access list can be arranged. As an example, the authorized access list 165 of FIG. 1 can identify both an authorized originating device and information that the authorized originating device may access. For example, a user of the receiving device 130 may store various types of information in the information store 160, including contact information in a phonebook or a calendar that shows appointments or other scheduled events. The user of the receiving device 130 may wish to grant access to certain types of information stored in the information store 160 to the user of the originating device 120. To do so, the user of the receiving device 130 can, as an example, select from a menu the caller identification (ID) of the originating device 120 or can enter that information through a user interface, which can cause the originating device 120 to be recognized as an authorized unit. The user of the receiving device 130 can also select which information in the information store 160 the originating device 120 is authorized to receive.

It must be noted that the authorized information is not necessarily limited to being stored in the receiving device 130, as the information can be contained in other suitable components. Moreover, those of skill in the art will appreciate that there may be other ways to grant authorization to the originating device 120.

At step 212, at an originating device, a receiving device can be selected and information to be accessed from the receiving device can be identified, as shown at step 214. At step 216, a communication that includes a silent fetch request can be initiated at the originating device.

For example, a user of the originating device 120 may need to access information that the user knows is or may be stored in the receiving device 130 or some other component associated with the receiving device 130. The user of the originating device 120 can, for example, select the receiving device 130 from a menu or some other interface and can identify the information that he/she wishes to acquire. The information request may be generated by any suitable interface. In one embodiment, the user may simply speak into the originating device 120, and the user's captured voice command may be converted into a text command. As another example, the user may simply enter a text command through a keypad of the originating device 120 or may select a command through a pre-existing menu of the device 120.

Once the receiving device 130 is selected and the desired information is identified, the user of the originating device 120 may initiate a communication that includes a silent fetch request. For example, the originating device 120 may include a PTT button (not shown), which can cause a PTT communication to be initiated. This PTT communication can include the silent fetch request, which can contain the identity of the originating device 120 and the information request.

Referring to FIG. 3, an example of a communications channel 300 and a data packet 310 are shown. The silent fetch request can be transmitted over this channel 300, which, as an example, can be a traffic channel that is capable of carrying voice and/or data. Those of skill in the art will appreciate that packetized data can be utilized to conduct communications over the channel 300 between the originating device 120 and the receiving device, and the data packet 310 represents an example of such. To allow the receiving device 130 to identify the PTT communication as a silent fetch request, the packet 310 can include a preamble 320.

Moving back to FIG. 2, at step 218, the silent fetch request can be received at the receiving device. Once received, the authorization of the originating device can be checked, as shown at step 220. Further, if the originating device is an authorized device, the requested information can be fetched, as shown at step 222. At step 224, the fetched information can then be transmitted to the originating device. At step 226, the silent fetch request may be delayed at the receiving device based on a predetermined condition.

For example, the receiving device 130 can receive the silent fetch request, which it can identify through the preambles 320 of the incoming data packets 310. The authorizing unit 170 can process the data packets 310 and can determine the identity of the originating device 120 and the type of information being requested. The authorizing unit 170 can then determine whether the originating device 120 is an authorized device and whether it is permitted access to the requested information by comparing the processed data with the authorized access list 165. If the originating device 120 is not an authorized device or does not have permission to access the requested information, the request can be ignored or the receiving device 130 can signal the originating device 120 that the request has been denied.

If, however, the originating device 120 is an authorized unit and is allowed access to the desired information, the authorizing unit 170 can signal the fetching unit 180 to fetch the information. For example, upon positive confirmation from the authorizing unit 170, the fetching unit 180 can retrieve the information from the information store 160. In another arrangement, the fetching unit 180 may obtain the information from another source. For example, the requested information may be stored in the network server 140, rather than the information store 160. In this example, the fetching unit 180 can signal the network server 140 (or any other suitable component) to retrieve the information.

Once the requested information has been fetched, the information can be transmitted to the originating device 120. In particular, the fetching unit 180 can signal the transceiver 150 to transmit the information pulled from the information store 160 to the device 120. In another arrangement, information retrieved from a source other than the receiving device 130, such as the network server 140, can be sent to the receiving device 130, which can then forward the retrieved information to the originating device 120. If desired, the information acquired from a source other than the receiving device 130 can be transmitted to the originating device 120 directly from that source.

There are several alternative protocols for transmitting the information to the originating device 120. For example, the information can be transmitted over the communication channel 300 using iExchange, Reliable User Datagram Protocol (RUDP) or Transmission Control Protocol (TCP). The type of protocol used to transport the data can depend on the type of information that is being transmitted. In any event, one of skill in the art will appreciate that there are numerous possibilities for ensuring that the information is efficiently transmitted, as the protocols listed above are merely recites as examples.

Following transmission, the user at the originating device 120 can access the information, such as through any suitable user interface. It must also be noted that the information can be transmitted to another component in addition to or in lieu of the originating device 120. As an example, the user of the originating device 120 can simply select a different or supplemental destination during the initiation of the silent fetch request.

The process described above can be useful because the receiving, checking, fetching and transmitting steps can be executed without the assistance of the user of the receiving device 130. That is, the user of the receiving device 130 is not required to take any active steps to cause the requested information to be transmitted to the originating device 120 (or other suitable component). As such, interruptions to the user of the receiving device 130 can be kept to a minimum. If desired, the user of the receiving device 130 can be notified of the transfer of the information through any suitable means, including a visual message or an audio notification. The user of the receiving device 130 may also be given an opportunity to change any settings on the authorized access list 165.

In one arrangement, the silent fetch request can be delayed at the receiving device 130 based on a predetermined condition. For example, the user of the receiving device 130 may be on an existing call when the receiving device 130 receives the silent fetch request, and the request can be delayed until the existing call is terminated. This process can be helpful if the receiving unit 130 only contains one transceiver 150, which can give the priority to the existing call, or if it has multiple transceivers 150, which can prevent the user from being subjected to multiple and simultaneous transmissions.

The silent fetch request can be delayed at any suitable stage. For example, the information can be retrieved, but the transmission of the information can be delayed until the condition warranting the delay passes. As another example, the silent fetch request can be received, but the actual retrieval of the date may not occur until the predetermined condition is over. It must be noted that the predetermined condition is not limited to an existing call, as those of skill in the art appreciate that there may be other reasons why it may be necessary to delay the retrieval and/or transmission of the requested information.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for silently fetching information, comprising:
receiving a silent fetch request from an originating device over a wireless communication channel, wherein the silent fetch request requests information;
checking the authorization of the originating device;
if the originating device is an authorized device, fetching the requested information; and
transmitting the fetched information to the originating device.

2. The method according to claim 1, wherein fetching the requested information comprises fetching the requested information from a receiving device or from a network server with which the receiving device is associated.

3. The method according to claim 2, further comprising signaling the network server from the receiving device if the receiving device does not contain the requested information.

4. The method according to claim 1, wherein the wireless communication channel is a traffic channel that supports at least push-to-talk communications.

5. The method according to claim 2, further comprising executing the receiving, checking, fetching and transmitting steps without the assistance of a user of the receiving device.

6. The method according to claim 1, wherein the silent fetch request from the originating device is a speech-to-text conversion.

7. The method according to claim 2, wherein the silent fetch request includes a preamble that the receiving device processes to identify the silent fetch request.

8. The method according to claim 2, further comprising delaying the silent fetch request at the receiving device based on a predetermined condition.

9. The method according to claim 8, wherein the predetermined condition is a pre-existing active communication that is conducted on the receiving device.

10. The method according to claim 1, further comprising arranging an authorized access list that identifies both an authorized originating device and information that the authorized originating device may access.

11. A method for silently fetching data, comprising:
at a wireless originating device, selecting a wireless receiving device;
identifying information to be accessed from the wireless receiving device;
at the wireless originating device, initiating a communication that includes a silent fetch request, wherein the silent fetch request indicates to the wireless receiving device the identity of the wireless originating device and the information to be accessed without the assistance of a user of the wireless receiving device.

12. The method according to claim 11, wherein identifying information to be accessed comprises converting a voice command captured at the originating device into a text command.

13. The method according to claim 11, wherein the initiated communication is a push-to-talk communication.

14. A mobile device for silently fetching information, comprising:
an information store that stores information;
a transceiver that receives a silent fetch request for information from an originating mobile device;
an authorizing unit coupled to the transceiver, wherein the authorizing unit checks the authorization of the originating mobile device; and
a fetching unit coupled to the information store, the transceiver and the authorizing unit, wherein upon positive confirmation from the authorizing unit, the fetching unit fetches the requested information from the information store and the transceiver transmits the requested information to the originating mobile device.

15. The mobile device according to claim 14, wherein the mobile device is associated with a network server and wherein the fetching unit signals the network server when the requested information is contained in the network server.

16. The mobile device according to claim 14, wherein the transceiver receives the silent fetch request over a wireless traffic channel that supports push-to-talk communications.

17. The mobile device according to claim 14, wherein the fetching unit fetches the requested information from the information store and the transceiver transmits the requested information to the originating mobile device without the assistance of a user of the mobile device.

18. The mobile device according to claim 14, wherein the fetching unit delays taking action based on a predetermined condition.

19. The mobile device according to claim 18, wherein the predetermined condition is the transceiver actively supporting a pre-existing communication.

20. The mobile device according to claim 14, further comprising an authorized access list that contains identifiers for authorized originating mobile devices and information that the authorized mobile devices are permitted to access.
